(19) United States
(12) Patent Application Publication
(10) Pub. No.: US 2009/0126636 A1
(43) Pub. Date: May 21, 2009

(54) Combined punch and needle for automated egg injection machines

(76) Inventors: Rafael S. Correa, Salisbury, MD (US); Mark A. Dekich, Salisbury, MD (US); William D. Samson, Salisbury, MD (US); Erich F. Bevensee, Eden, MD (US)

Correspondence Address: JACOBSON HOLMAN PLLC, 400 SEVENTH STREET N.W., SUITE 600, WASHINGTON, DC, 20004, US

(21) Appl. No.: 11/984,757

(22) Filed: Nov. 21, 2007

(51) Int. Cl. A01K 45/00

(52) U.S. Cl. 119/6.8

(57) ABSTRACT

An improved needle design is cut diagonally from two sides to form a sharpened cutting edge, rather than a point. The needle has an external diameter and wall thickness sufficient to provide the rigidity necessary to punch the egg shell while the sharpened edge provides a sharp cutting edge able to sever the underlying membrane cleanly and penetrate an embryo if necessary. The needle's penetrating edge design prevents needle tip fold-over and the resulting formation of a hook which can lead to cross-contamination of eggs and shortened needle life.

### BACKGROUND OF THE INVENTION

1. Field of the Invention

The present invention is related to the field of improved needle designs for in ovo vaccination and, more particularly, to a combined punch and needle design for use with an automated egg injection machine.

2. Description of the Related Art

Needles used for injection of vaccines are typically cut diagonally from one side to the other. This creates a sharp point suitable for penetrating relatively soft surfaces such as human skin.

The process of in ovo vaccination, on the other hand, requires that a needle penetrate two surfaces, each having distinct qualities which creates mechanical challenges. The egg shell is hard, rigid, brittle and abrasive, while the membrane within the shell is soft, moist and pliable. The typical needle with its diagonal cut and sharp point is suited for penetrating the membrane but not for repeated punching of hard, brittle egg shells.

Due to the differences in these two surfaces, the principal prior art approach utilizes a dual punch-needle system having an injection needle inside another needle which acts as a punch. Examples of such systems are disclosed in U.S. Pat. Nos. 5,056,464 and 5,136,979. The external needle (or punch) has a larger diameter to make it stronger and therefore capable of penetrating the egg shell multiple times before reaching a failing point. The internal needle has a smaller diameter and is sharper to facilitate membrane penetration. The internal needle cannot be used to penetrate the egg shell because the smaller-diameter tip will fold over upon impact and form a hook or “J” shape, i.e., needle tip fold-over. The same needle tip fold-over will also be imparted to the external needle after significant use, as representatively shown in drawing FIGS. 1, 2 and 2A. As shown, over time and repeated egg shell penetration, the leading edge 10 of the needle 12 becomes distorted, forming the hook 14 and increasing the force necessary to pierce the egg shell.

While this dual punch-needle system makes the in ovo process possible, it is not without its challenges. For one, as stated above, the larger external needle or punch will begin to take on the “J” shape after significant use. If the distorted needle then punches a contaminated egg, the hook will entrap the contaminant and carry it to the next several eggs. This same hook also has the potential to lift eggs as the punch retracts and to thereafter drop them on top of other eggs, thus damaging and/or contaminating other eggs.

Another challenge arises from the wear and tear suffered by the smaller diameter inner needle due to friction between the adjacent rubbing surfaces of the two needles. This wear and tear can lead to inner needles that bend easily during the injection process. The life expectancy of the larger diameter outer needle or punch is also compromised and, while dependent upon egg shell quality and quantity of eggs punched, is typically only one to two weeks.

Furthermore, the space between the two adjacent needle surfaces traps pathogens and contamination and is difficult to sanitize and decontaminate. The sanitation process designed to take care of this condition does not have sufficient volume or pressure to properly disinfect this sensitive area. Instead, the sanitation fluid will travel the path of least resistance, leaving areas where the needles are tangent without sanitation, thus providing another source of cross-contamination.

In an effort to address the above considerations, the assignee of the present invention developed a needle design having a blunt tip 16 as shown in FIGS. 3 and 4. This prior art needle design has been used on the INTELLIJECT® automated egg injection machine made and marketed by AviTech, LLC of Salisbury, Md. The needle is cut at an angled surface such that one side of the needle is longer than the other, with the angled surface being on the order of about 60° relative to the inside surface of the needle lumen adjacent the longer side. Instead of having the angled surface extend completely across the full width of the needle, the longer side of the needle is cut perpendicular to the length of the needle to form the blunt tip 16. The blunt tip 16 makes initial contact with the egg and, having a thickness of between about seven and thirteen thousands of an inch (0.007″ to 0.013″), provides a sufficiently strong surface of impact to prevent needle tip fold-over.

However, in addition to the negative impact of needle tip roll-over on needle life and sanitation, it is also believed that use of the foregoing prior art needle designs can present significant risk to the developing avian embryos.

### SUMMARY OF THE INVENTION

In order to overcome the foregoing drawbacks of the prior art, as well as other problems and disadvantages of prior art needle designs, the present invention seeks to provide an improved needle design for a pneumatically operated injection assembly of an automated egg injection machine such as disclosed in U.S. Pat. No. 7,185,603 (“the '603 patent”), the disclosure of which is expressly incorporated herein by reference as if fully set forth. The improved needle design is directed to an injecting tip which is cut diagonally from two sides to form a sharpened cutting edge, rather than a point, enabling the needle to effectively penetrate both the egg shell and the underlying membrane while providing an extended needle life. The needle has an external diameter and wall thickness sufficient to provide the rigidity necessary to punch the egg shell while preventing needle tip fold-over and the resulting formation of a hook. In addition, the cutting edge forming the tip is sharpened with a combination of angles that not only provide additional resistance to needle tip fold-over but also provide a sharp cutting edge to pierce an 18 day embryo so as to avoid embryo flip, even if contact is made.

Accordingly, it is an object of the present invention is to provide a single needle which can be used in the injection assembly of an automated egg injection machine to penetrate both the egg shell and the underlying membrane.

Another object of the present invention is to provide a needle in accordance with the preceding object for use in a pneumatically operated injector and which has a tip in the form of an edge that is sharpened with multiple angles to prevent bending or needle tip fold-over.

A further object of the present invention is to provide an egg injection machine needle in accordance with the preceding objects and which is able to penetrate both the egg shell and the underlying membrane and pierce the embryo so as to minimize or eliminate embryo flip in 18 day old embryos.

Yet another object of the present invention is to provide an egg injection machine needle in accordance with the preceding objects and which reduces the risk of cross contamination between eggs.

A still further object of the present invention is to provide an egg injection machine needle in accordance with the preceding objects and which has an angled edge cut from two sides to form the tip, the edge providing both sharpness and strength, resulting in extended needle life.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a perspective view of a conventional prior art needle after sufficient use to form a hook on the leading edge of the tip.

FIG. 2 is a side view of the needle of FIG. 1.

FIG. 2A is a detailed view of area “A” of FIG. 2.

FIG. 3 is a perspective view of another needle design known in the art having a blunt leading edge to resist needle tip fold-over.

FIG. 4 is a side view of the needle of FIG. 3.

FIG. 5 is a perspective view of a needle tip having an angled edge in accordance with a first embodiment of the present invention.

FIG. 6 is a side view of the needle tip of FIG. 5.

FIG. 7 is an end view taken along line 7-7 of FIG. 6.

FIG. 8 is another perspective view of the needle tip of FIG. 5.

FIG. 9 depicts a needle tip having diagonal cuts in the lower angular range at 22.50° to produce a cutting edge having an angle of 45° in accordance with the present invention.

FIG. 10 depicts a needle tip having diagonal cuts in the upper angular range at 45° to produce a cutting edge having an angle of 90° in accordance with the present invention.

FIG. 11 depicts a needle tip having diagonal cuts of 30° to produce a cutting edge having a preferred angle of 60° in accordance with the present invention.

FIG. 12 is a side view of a needle tip having an angled edge in accordance with a second embodiment of the present invention and incorporating the preferred angle of FIG. 11.

FIG. 13 is a perspective view of the needle tip of FIG. 12.

FIG. 14 is an end view taken along line 14-14 of FIG. 12.

FIG. 15 is another perspective view of the needle tip of FIG. 12.

FIG. 16 is a perspective view of a needle tip having an angled edge in accordance with a third embodiment of the present invention.

FIG. 17 is another perspective view of the needle tip of FIG. 16.

FIG. 18 is a side view of the needle tip of FIG. 16.

FIG. 19 is an end view taken along line 19-19 of FIG. 18.

FIG. 20 is a perspective view of a needle tip having an angled edge tip in accordance with a fourth embodiment of the present invention.

FIG. 21 is a side view of the needle tip of FIG. 20.

FIG. 22 is an end view taken along line 12-22 of FIG. 21.

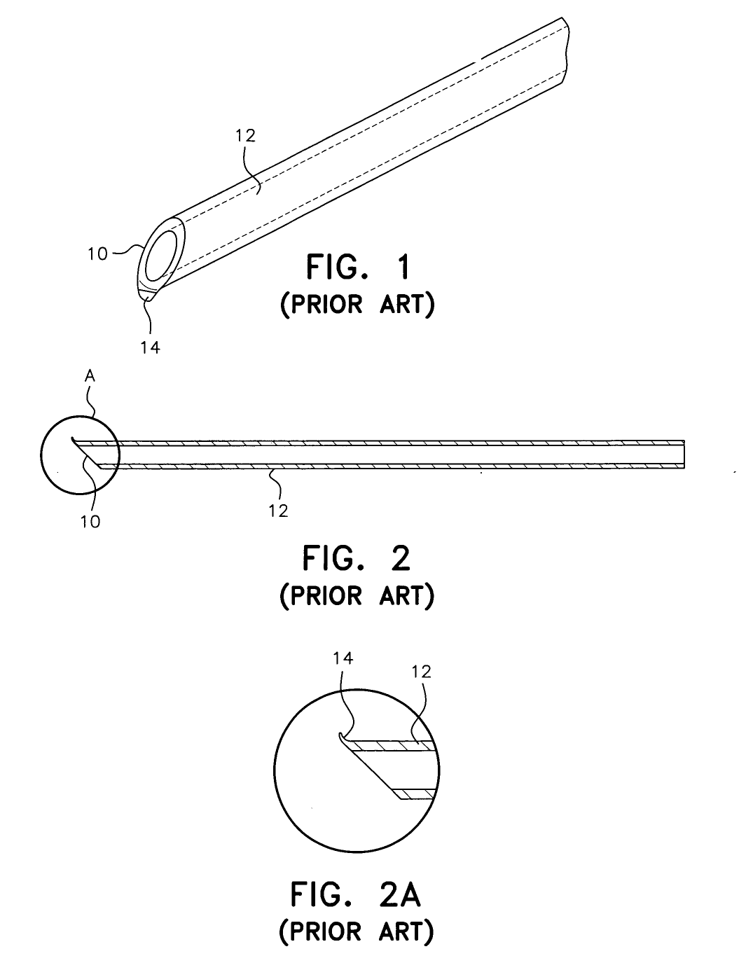

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

The present invention is directed to a needle for use with an automated egg injection machine such as the INTELLIJECT® automated egg injection machine manufactured and marketed by the assignee of this invention. An early version of the INTELLIJECT® machine is disclosed in the '603 patent previously incorporated by reference. The needle has an injection tip that is cut diagonally from two sides to form a cutting edge. The cutting edge forms the egg-contacting surface which, because of its width as compared with conventional pointed tips, demonstrates improved durability and punch capability as compared with prior art designs.

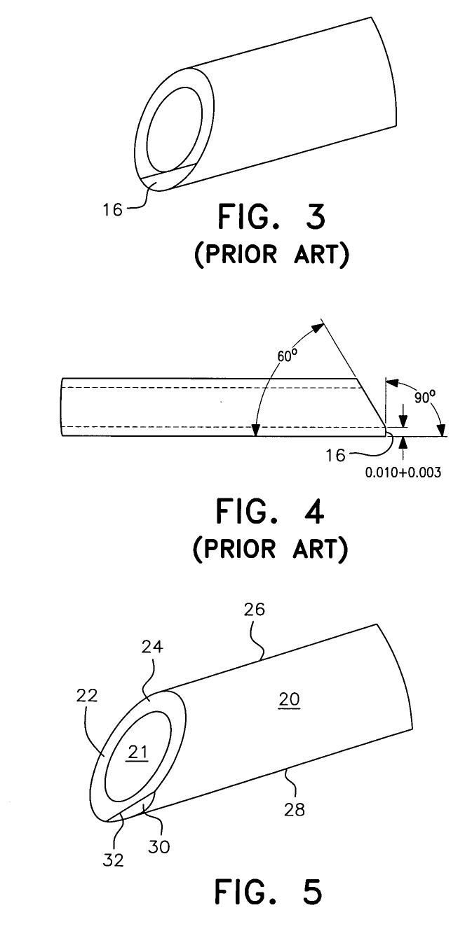

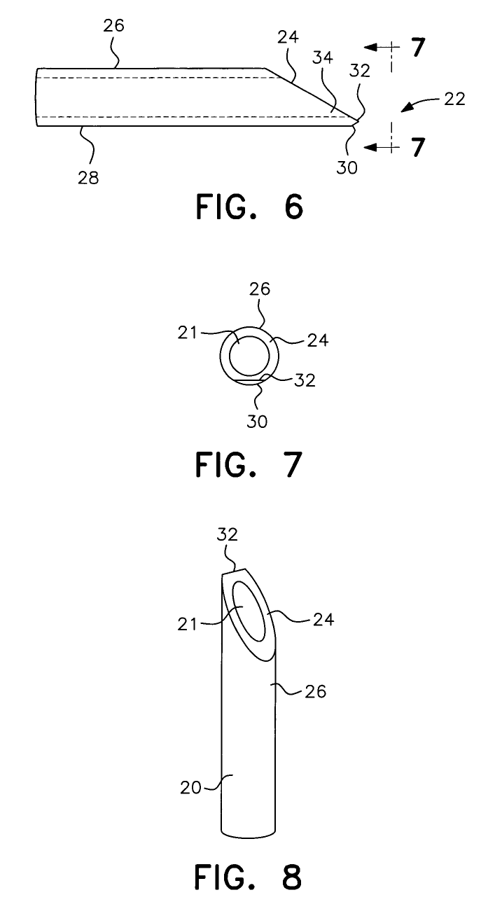

According to a first embodiment as shown in FIGS. 5-8, the present invention is directed to a needle or cannula 20 having a lumen 21 and a tip generally designated by the reference numeral 22. The tip 22 has an angled surface 24 formed by cutting the majority of the tip at a first oblique angle. This results in the needle having a short side 26 and a long side 28. However, unlike the perpendicular cut of the long side as in FIGS. 3 and 4, only a portion 30 of the long side is cut at an angle different from the slope of the angled surface 24. This portion 30 is cut at a second oblique angle relative to the needle sides so as to form an acute angle with the surface 24. This acute angle creates a sharp leading or cutting edge 32 on the tip 22 of the needle. As the initial contact surface with the egg, the sharp cutting edge 32 penetrates the egg shell easily, reducing the force required to pierce the shell and thus, in turn, reducing shock to the egg and preventing embryo flip in 18 day old embryos. The sharp cutting edge 32 also distributes the wear associated with repeated egg contact across a greater surface area than with the pointed tips known in the prior art.

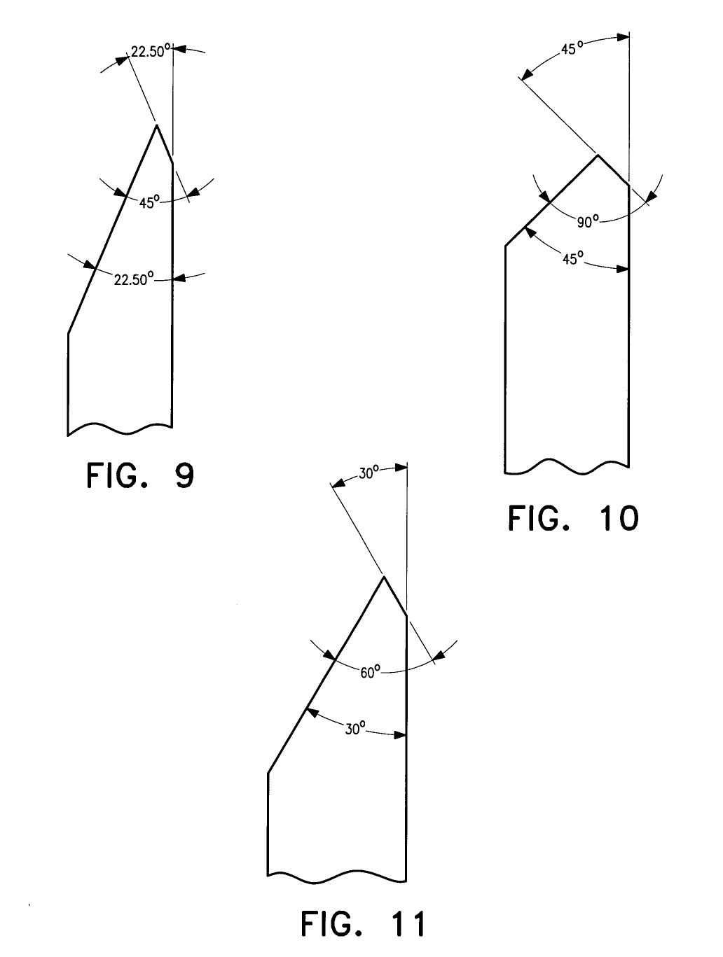

The needle 20 in FIGS. 5-8 should have an external diameter between about forty thousands of an inch (0.040″) and about seventy thousands of an inch (0.070″), preferably about fifty thousands of an inch (0.050″). The needle 20 should preferably have a wall thickness of approximately ten thousands of an inch (0.010″) within normal manufacturing tolerances (+/−0.002″), i.e., 0.008 inches to 0.012 inches. This structural strength, combined with the sharpened edge 32, virtually eliminates the possibility of needle tip fold-over and “J” shape formation. Needle tip fold-over is further prevented by the angle at which the surface 24 is cut relative to the second angle at which the portion 30 is cut. As illustrated in FIGS. 9-11, the two diagonal cuts preferably can vary in angle from about 22.5° to about 45° with a more preferred angle being on the order of about 30° such that the acute angle between the angled surface 24 and the portion 30 cut at the second angle can vary in angle from about 45° to about 90°, with a more preferred angle being on the order of about 60°.

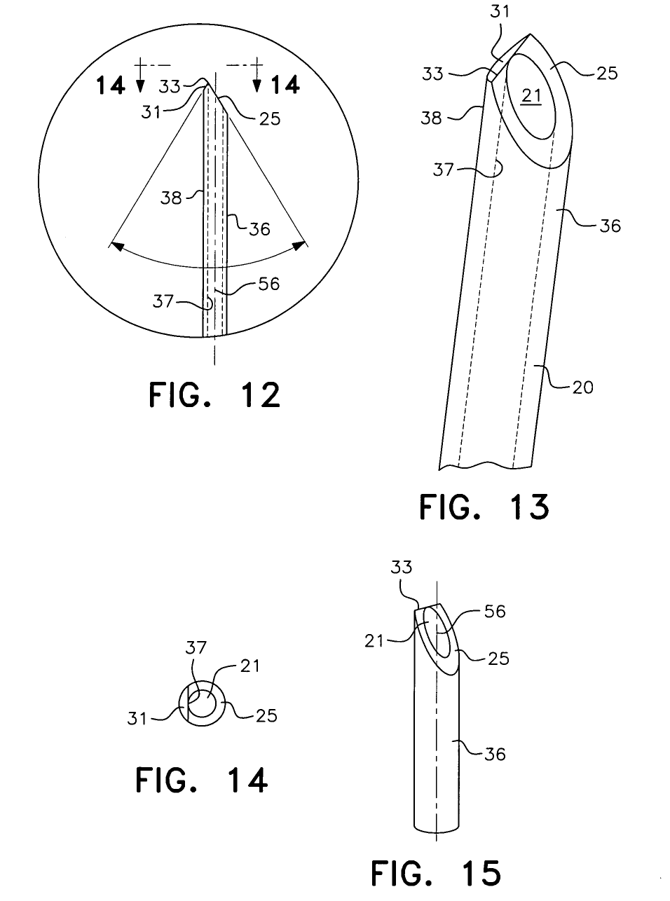

A second embodiment of the present invention is shown in FIGS. 12-15. As in the first embodiment, an angled surface 25 is formed by cutting the majority of the tip at a first oblique angle, creating a short side 36 and a long side 38. A portion 31 of the long side 38 is cut at a second oblique angle so as to form an acute angle with the angled surface 25. The portion 31 cut at the second angle in the embodiment shown in FIG. 12-15 is larger than in the first embodiment. This creates a leading edge 33 on the tip of the needle that is offset from the longitudinal axis 56 of the lumen 21 and tangent to the inner diameter 37 of the lumen 21 adjacent the long side 38.

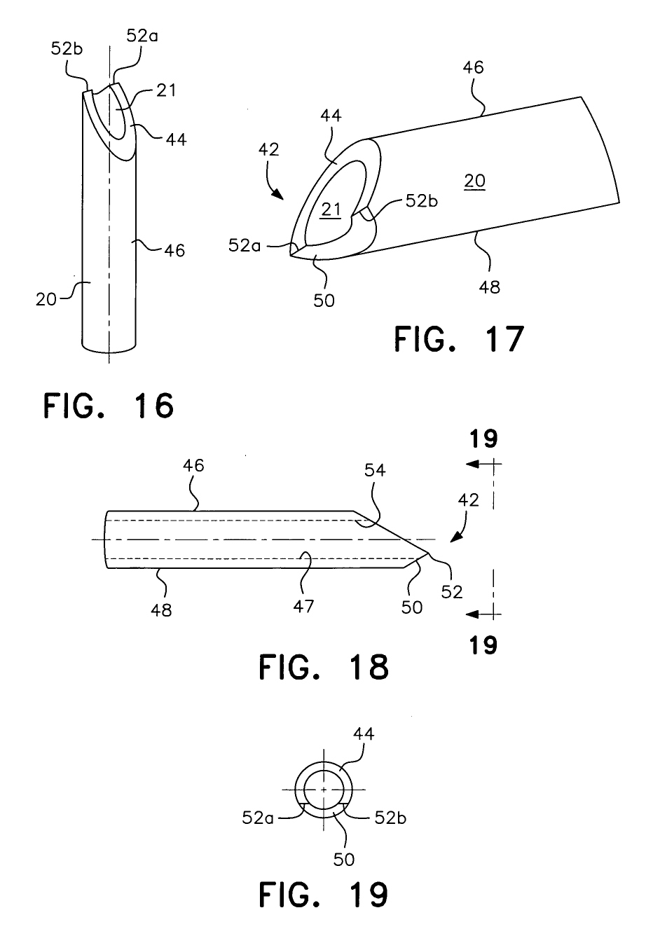

A third embodiment of the present invention is shown in FIGS. 16-19. As in the first and second embodiments, an angled surface 44 is formed by cutting the majority of the tip, generally designated by reference numeral 42, at a first oblique angle, creating a short side 46 and a long side 48. A portion 50 of the long side 48 is cut at a second oblique angle so as to form an acute angle with the angled surface 44. The portion 50 cut at the second angle is larger than in the first and second embodiments. This creates a leading edge 52 on the tip 42 of the needle that has two cutting portions 52a, 52b spaced from one another by a portion of the lumen 21. The intersection of the portion 50 and the angled surface 44, including the two cutting portions 52a, 52b, is offset from the inside diameter 47 of the lumen on the long side 48 and also from the longitudinal axis 56 of the lumen 21.

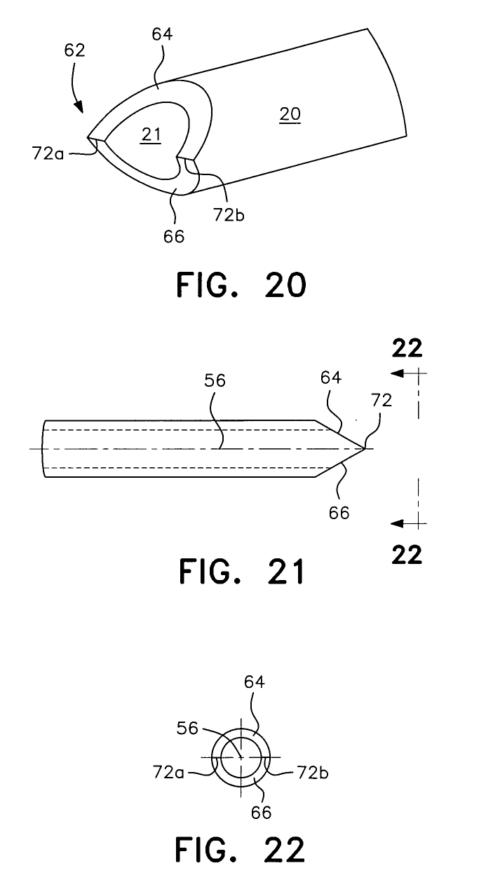

A fourth embodiment of the present invention is shown in FIGS. 20-22. As shown, the tip, generally designated by reference numeral 62, of the needle is cut at two oblique angles intersecting along the longitudinal axis 56 of the lumen to form opposing angled surfaces 64 and 66 of approximately equal size and slope. The preferred angle of slope for both surfaces 64, 66, with respect to the longitudinal axis 56, is on the order of about 30°, resulting in an angle between the surfaces of about 60°. Because the surfaces 64, 66 intersect along the longitudinal axis 56, the leading edge 72 of the needle tip 62 has two cutting portions 72a, 72b spaced from one another by the diameter of the lumen. These two cutting portions 72a, 72b, being on opposing sides of the needle wall, provide both a very sharp and an extremely durable impact surface.

As with the first embodiment, the needles according to each of the second, third and fourth embodiments also should have an external diameter between about forty thousands of an inch (0.040″) and about seventy thousands of an inch (0.070″), preferably about fifty thousands of an inch (0.050″), and should preferably have a wall thickness of approximately ten thousands of an inch (0.010″) within normal manufacturing tolerances (+/−0.002″), i.e., 0.008 inches to 0.012 inches.

The manner of sharpening the needle tip to form a leading edge that spans part or all of the needle width as just described results in a needle having the strength to punch through the egg shell and the sharpness to penetrate the membrane and the embryo so as to avoid flipping an embryo at only 18 days old. This construction also results in reduced contamination, otherwise caused by entrapment areas created when the needle tip is deformed, and a longer needle life.

Other angles and angle combinations may also be implemented on the needle tip as long as the penetrating surface remains an edge rather than a point that could potentially fold and form a hook after repeated contact with the egg shell. Hence, the minimum condition is to cut the needle to an extent equal to a part of the width or thickness of the needle wall.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An improved needle for an automated egg injection machine having a needle wall and a lumen for in ovo vaccination with an automated egg injection machine, the improvement comprising an injection tip having two angled surfaces cut diagonally from two sides of the needle wall to form a cutting edge that spans at least part of a width of the needle wall.

2. The improvement as set forth in claim 1, wherein said angled surfaces are cut at angles of from about 22.5° to about 45°.

3. The improvement as set forth in claim 1, wherein one of said angled surfaces is larger than the other.

4. The improvement as set forth in claim 1, wherein said angled surfaces are substantially equal in size.

5. The improvement as set forth in claim 1, wherein said cutting edge is aligned with a longitudinal axis of said needle.

6. The improvement as set forth in claim 1, wherein said cutting edge is offset from a longitudinal axis of said needle.

7. The improvement as set forth in claim 6, wherein said cutting edge is tangent to said lumen.

8. The improvement as set forth in claim 1, wherein an angle between said two angled surfaces is between about 45° and about 90°.

9. The improvement as set forth in claim 1, wherein an angle between said two angled surfaces is about 60°.

10. A needle for in ovo vaccination using an automated egg injection machine comprising a cylindrical needle wall and an injection tip cut diagonally from two sides of the needle wall to form a cutting edge that spans at least part of a width of the needle wall.

11. The needle as set forth in claim 10, wherein said injection tip is cut from two sides at angles of from about 22.5° to about 45°.

12. The needle as set forth in claim 10, wherein said edge separates two angled surfaces of said tip formed by said diagonal cuts.

13. The needle as set forth in claim 12, wherein one of said angled surfaces is larger than the other.

14. The needle as set forth in claim 12, wherein said angled surfaces are substantially equal in size.

15. The needle as set forth in claim 10, wherein said cutting edge is aligned with a longitudinal axis of said needle.

16. The needle as set forth in claim 10, wherein said cutting edge is offset from a longitudinal axis of said needle.

17. The needle as set forth in claim 16, wherein said cutting edge is tangent to an inside surface of a lumen of said needle.

18. The needle as set forth in claim 12, wherein an angle between said two angled surfaces is between about 45° and about 90°.

19. The needle as set forth in claim 12, wherein an angle between said two angled surfaces is about 60°.

20. An automated egg injection machine having an injection assembly which comprises a plurality of pneumatically operated injectors, each injector having an injection needle with a cylindrical needle wall and an injection tip cut diagonally from two sides of the needle wall to form two angled surfaces that meet to form a cutting edge that spans at least part of a width of the needle wall.
